(19) United States
(12) Patent Application Publication
(10) Pub. No.: US 2003/0065558 A1
(43) Pub. Date: Apr. 3, 2003

(54) Method and apparatus for multi-vendor powered business portal with intelligent service promotion and user profile gathering

(76) Inventors: Cameron Shaw, San Francisco, CA (US); Todd Goldman, Sunnyvale, CA (US); Matthew Leacock, Sunnyvale, CA (US); An Feng, Cupertino, CA (US)

Correspondence Address: GLENN PATENT GROUP, 3475 EDISON WAY, SUITE L, MENLO PARK, CA, 94025, US

(21) Appl. No.: 09/954,128

(22) Filed: Sep. 12, 2001

(51) Int. Cl. G06F 17/60

(52) U.S. Cl. 705/14

(57) ABSTRACT

A personalized marketing and registration wizard for businesses is provided. Data is gleaned from a portal profile database to drive one-to-one marketing, registration, upselling, and cross-selling of partner services and centralized portal tools. Using the portal profile database, up-to-date user profile information is collected and shared across multiple vendors. The portal profile database preferably is not accessible by vendors, and each vendor is responsible for storing a desired subset of the user profile in the vendor's own database. In this way, a quasi-intelligent portal for multiple tasks is provided, where each task comprises a business function promoted to an end user in a logical fashion, and such that tasks from various vendors are promoted to the end user in a consistent fashion.

### BACKGROUND OF THE INVENTION

1. Technical Field

The invention relates to portal applications. More particularly, the invention relates to a quasi-intelligent portal application for promoting business functions from various vendors to an end user in a logical and consistent fashion. The invention also relates to collecting up-to-date user profiles and sharing such profiles across multiple vendors.

2. Description of the Prior Art

Users of the Internet are sometimes businesses or individuals, such as entrepreneurs using the Internet on behave of a business. Such users benefit from services and tools on the Internet that help them to do their business in a more efficient way. Existing sites such as Yahoo and AOL provide a sense of community in order to leverage available content, technology, tools and services, such as instant messaging, and membership for their clients. Presently, sites that offer services and tools, content, technology, and the like to businesses do so in a fixed order and are inflexible. The provision and presentation does not take advantage of an end user's status with respect to which tool and services, content, and the like, to which he or she has availed himself or herself.

It would be advantageous to provide fast one-to-one targeted promotion to a user based on user status, to provide integration capability with many partner services without requiring a user to repeatedly provide profile attributes, to provide dynamical page creation for collecting user profile information with minimum effort, and to provide unified profile exchange mechanisms, such as dump, instant fetching/editing, or by announcement to create efficiencies in administration tasks, to improve communication, to improve marketing, and to provide deep services and vertical content by industry.

### SUMMARY OF THE INVENTION

A personalized marketing and registration wizard for businesses is provided. Data is gleaned from a portal profile database to drive one-to-one marketing, registration, upselling, and cross-selling of partner services and centralized portal tools. Using the portal profile database, up-to-date user profile information is collected and shared across multiple vendors. The portal profile database preferably is not accessible by vendors, and each vendor is responsible for storing a desired subset of the user profile in the vendor's own database. In this way, a quasi-intelligent portal for multiple tasks is provided, where each task comprises a business function promoted to an end user in a logical fashion, and such that tasks from various vendors are promoted to the end user in a consistent fashion.

### BRIEF DESCRIPTION OF THE DRAWINGS

FIG. 1 is an example of a marketing and registration widget according to the preferred embodiment of the invention;

FIG. 2 is an example of a marketing and registration widget situated on an end user's home page of the portal according to the preferred embodiment of the invention;

FIG. 3 is an example of a benefits page for greater detail on an offered service according to the preferred embodiment of the invention;

FIG. 4 shows an example Contact tab on an online business card according to the invention;

FIG. 5 shows an example Products & Services tab on an online business card according to the invention;

FIG. 6 shows an example About Us tab on an online business card according to the invention;

FIG. 7 shows an example What's New tab on an online business card according to the invention;

FIG. 8 is a flow diagram showing nine steps of the registration signup process according to the invention;

FIG. 9 is a flow diagram of the part of the marketing and registration wizard pertaining to the registration process according to the invention;

FIG. 10 is a flow diagram of the part of the marketing and registration wizard pertaining to the marketing process according to the preferred embodiment of the invention;

FIG. 11 is a flow diagram of profile editing according to a preferred embodiment of the invention;

FIG. 12 shows configuration data that the SB portal provides to SB partner sites according to the invention;

FIG. 13 shows configuration data that the SB partner sites must supply to the SB portal for each service according to the invention;

FIG. 14 shows lists of SB business profile attributes that are available to partner sites according to the invention;

FIG. 15 shows lists of SB business profile attributes that are available to partner sites according to the invention;

FIG. 16 shows lists of SB business profile attributes that are available to partner sites according to the invention;

FIG. 17 shows lists of SB business profile attributes that are available to partner sites according to the invention;

FIG. 18 shows lists of SB business profile attributes that are available to partner sites according to the invention;

FIG. 19 shows lists of SB business profile attributes that are available to partner sites according to the invention;

FIG. 20 shows lists of SB business profile attributes that are available to partner sites according to the invention;

FIG. 21 shows lists of SB business profile attributes that are available to partner sites according to the invention;

FIG. 22 shows profile attributes represented by XML elements according to the invention;

FIG. 23 shows XML elements used to organize profile attributes of FIG. 22 according to the invention;

FIG. 24 shows XML elements used for representing a profile dump according to the invention;

FIG. 25 illustrates the overall page flow during a service sign-up process according to the invention;

FIG. 26 provides additional details of FIG. 25 according to the invention;

FIG. 27 illustrates the overall page flow for instant profile fetching/editing according to the invention; and

FIG. 28 provides additional details, such of FIG. 27 according to the invention.

### DETAILED DESCRIPTION OF THE INVENTION

A marketing and registration vehicle used by a centralized portal to help aggressively promote partner functionality and to grow partner traffic is provided.

The preferred embodiment of the invention comprises a personalized marketing and registration wizard for small businesses that gleans data from a centralized portal profile database to drive one-to-one marketing, registration, and upselling and cross-selling of partner services and use of portal tools. The marketing and registration wizard processes responses and sequences offerings. In essence, a quasi-intelligent portal for multiple tasks is provided, wherein each task is a business function promoted to an end user in a logical fashion, and wherein tasks from various vendors or partners are promoted to an end user in a consistent fashion, resulting in the end user having a pleasant user experience.

In the preferred embodiment of the invention the powerful wizard is located on a portal home page of a centralized business portal site. The wizard prompts an end user, for example, a small business owner to sign up for tools and items which assist the end user in getting on the fast track to success. The wizard displays a customized list of tools and/or tasks and associated benefits, but is not limited to such as its display can evolve in a fashion corresponding to and keeping up with how business technology evolves. Examples of such tools and items are marketing items comprising targeted advertising, special offers, and promotions. Thus, the claimed invention provides a fast one-to-one targeted promotion based on end user status.

According to the preferred embodiment of the invention, when an end user selects an item from a displayed list, the end user is guided through a registration sequence or process for that particular selection. The registration sequence or process is referred to as simply the registration wizard. The registration wizard is a feature for creating a dynamic page for collecting user profiles with minimum effort. An exemplary registration wizard is provided below in the section, An Exemplary Marketing and Registration Wizard Integration—Fast Track. When a selected item is provided by a partner, it should be appreciated that sometimes part of the registration sequence may be hosted or provided by the partner in associated partner pages.

According to the preferred embodiment of the invention, the marketing aspect of the wizard, referred to simply as the marketing wizard, features a list of partner service offerings that are dynamically presented to end users. Once an end user selects an item, such as a “track” or service offering and completes registration, the item is removed from the marketing wizard. Additionally, a task can be deleted or edited through a typical portal administration page. The marketing wizard area preferably includes a brief item, such as, for example, a service description and compelling benefits statement. Either of two such pieces of information preferably provide links to a benefits page provided by the portal, and which describes in greater detail reasons the end user should sign up for the service. When necessary, the benefits page then links to a partner-hosted registration page that is pre-populated with fields from the portal user profile database. Additional information may be captured at this point by users for partners. Explanations can be included for special or required fields to ensure that they are properly completed. Such data is preferably and exclusively stored in the partner's user profile database.

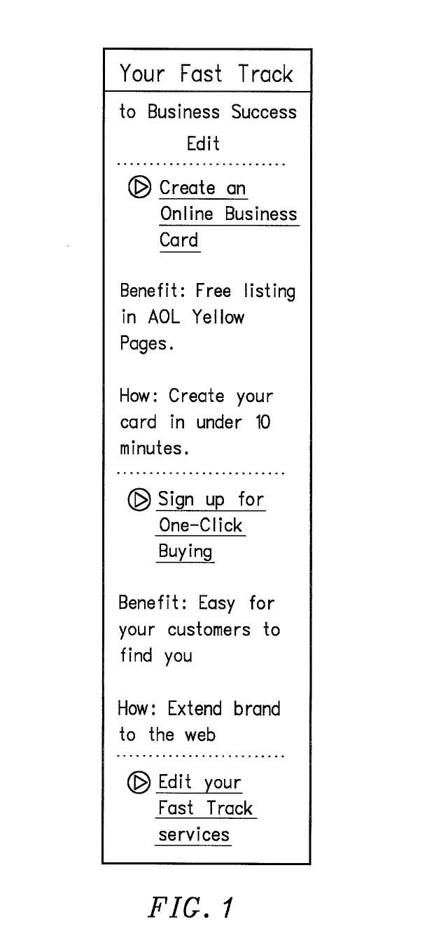

FIG. 1 is an example of a marketing and registration widget according to the preferred embodiment of the invention. At least two links are presented, each having a Benefit explanation and a How explanation below the link.

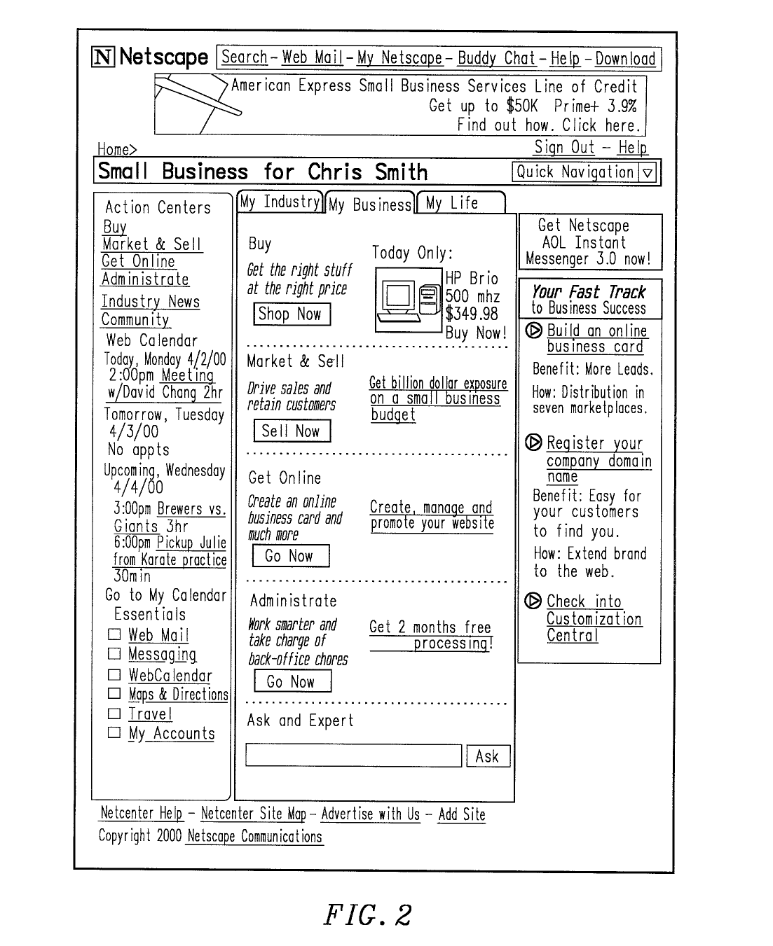

FIG. 2 is an example of a marketing and registration widget situated on an end user's home page of the portal according to the preferred embodiment of the invention. In this example, the marketing and registration wizard occupies part of the right hand column of a construction businessman's home page on the portal.

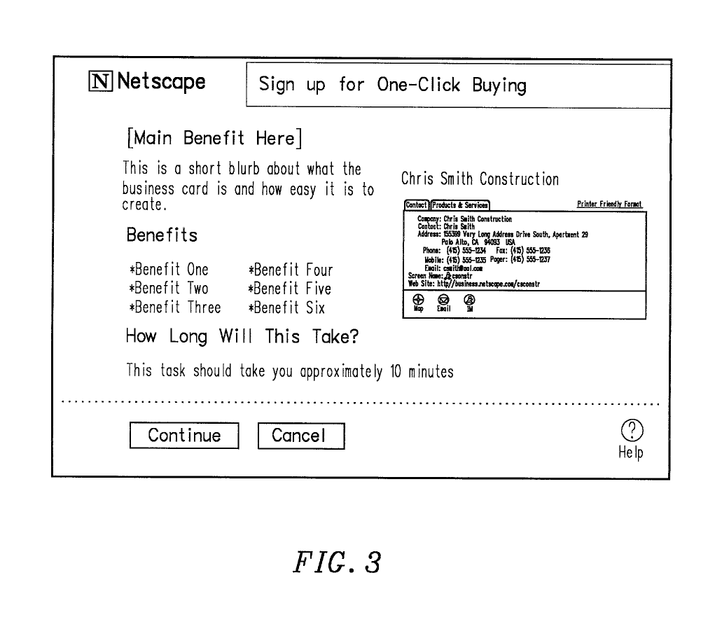

FIG. 3 is an example of a benefits page for greater detail on an offered service according to the preferred embodiment of the invention.

The preferred embodiment of the invention authenticates end users by working along with a proprietary site's authentication application. Authentication is defined as uniquely identifying an end user. Basic authentication information is stored in the proprietary site's authentication application user profile database. Thus, profile information is preferably stored in two databases, namely, that of the proprietary site's authentication application and that of the portal's site.

It should be appreciated that partners need to integrate the marketing and registration wizard when their contract with the portal site includes complex data synchronization, registration form pre-population, or upselling placement.

For gathering and subsequent storing of user profile information, the preferred embodiment of the invention provides an online business card as a main source, and the user profile data is shared among partners. Such user information from the business card is stored in the portal site's user profile database.

According to the preferred embodiment of the invention, the marketing and registration wizard is accessible to business portal site users who register for a customized home page. Business users registering for customized home pages preferably supply a vertical industry classification and a business zip code.

According to the preferred embodiment of the invention, partner integration uses HTTP request and response pairs and site handlers. All partners who have restricted-access sites or portions of sites require such integration.

Following is a list of preferred end user benefits of the marketing and registration wizard. It should be appreciated that such list is exemplary, and not necessarily exhaustive. The marketing and registration wizard:

Skips forms and/or parts of forms when registering for a new service by providing pre-populated forms from existing profiles, thereby eliminating redundant entry, even when going to a site for the first time;

Facilitates knowing what to expect before signing up by having partners provide a benefits summary and privacy policies. (A partner provides such information as part of the integration process and when the partner essentially asks for access to registration data); and

Facilitates and enables accessing a wider variety of practical services without having to complete additional forms.

Following is a list of preferred partner benefits of the marketing and registration wizard. It should be appreciated that such list is exemplary, and not necessarily exhaustive. The marketing and registration wizard:

Promotes products and services prominently and in a persistent section on a user's home page on the portal.

Online Business Card

The preferred embodiment of the invention provides a unique online business card sign up process. An end user enters contact information and simple product and service information, and is sent to a status page. At the status page, the end user can preview the contact and products and services sections, such as, for example, by using notebook tabs and verify that the information is accurate. The end user can also provide additional information for, such as, for example, About Us and What's New tabs.

The preferred embodiment of the invention performs business profile data reconciliation on the entered data by means of a business profile exchange feature. The business profile exchange feature facilitates and uses a partner connection that may occur at any or all entries to a registered partner space; it provides means for pushing a scheduled batch for data reconciliation and/or means for being triggered by an outdated profile version notation. Implementing such technology is known to one skilled in the art, and an exemplary implementation is described below. Such data reconciliation keeps profiles current.

It should be appreciated that partners may prefer instant fetching, wherein a partner retrieves profiles from databases each time end users log on to the partner's site. Partners may also opt to be completely out of profile sharing.

According to the preferred embodiment of the invention, an end user desiring to make profile changes is directed to a portal form to make any profile changes when profiles are shared among partners. The end user confirms profile changes with the proprietary authentication application's user profile database and with the portal profile database.

When signing up for the online business card is done, preferably a confirmation page is provided to the end user describing the feature, such as a service for which the end user just signed up. From this point forward, the partner service is readily accessible and registration seamless. The confirmation page also recommends next tracks based on user profile and a complete list of features, such as services to which the end user subscribed.

It should be appreciated that in the preferred embodiment of the invention, virtually all data in an end user's portal profile is entered or reviewed on an online business card. The card is created and accessed through an end user's customized portal home page. Each card preferably comprises, but is not limited to four sections: Contact, Products and Services, About Us, and What's New.

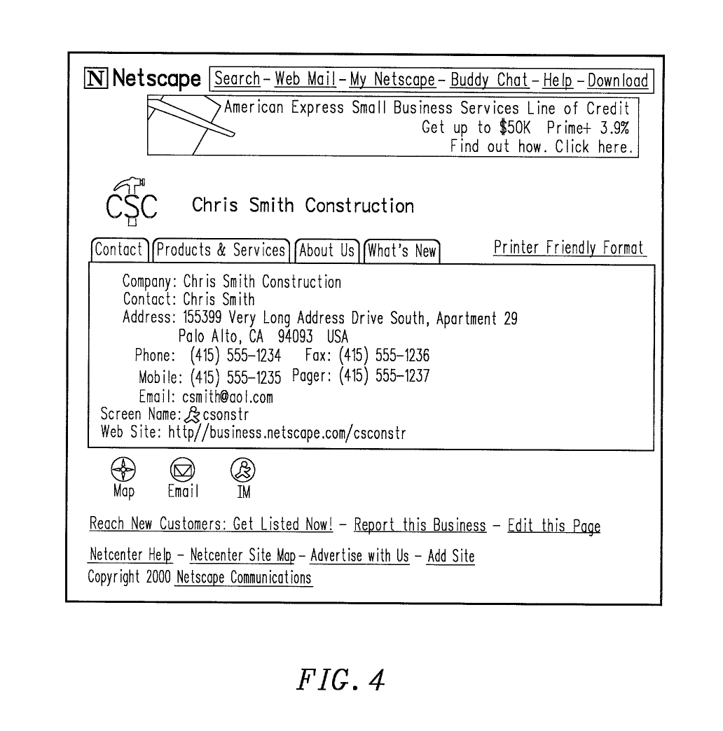

FIG. 4 shows an example Contact tab on an online business card according to the invention.

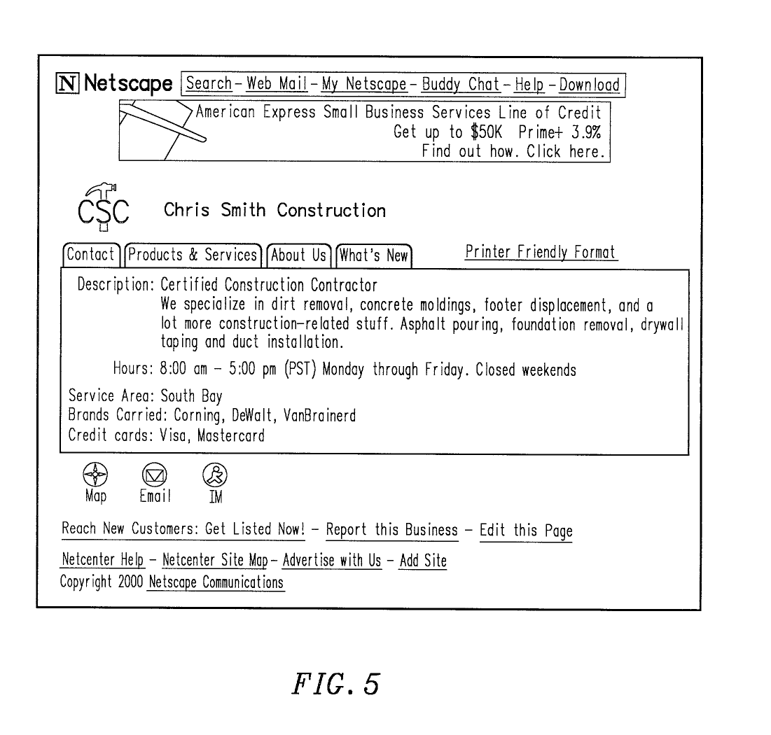

FIG. 5 shows an example Products & Services tab on an online business card according to the invention.

FIG. 6 shows an example About Us tab on an online business card according to the invention.

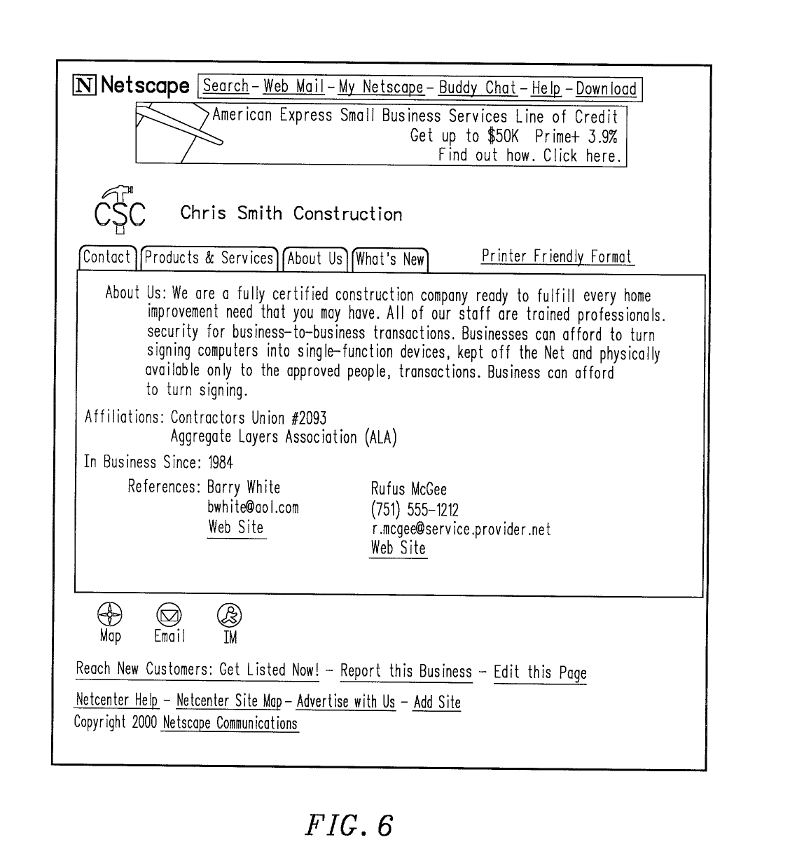

FIG. 7 shows an example What's New tab on an online business card according to the invention.

It should be appreciated that the preferred embodiment of the invention provides uniqueness by having no two online business cards sharing the same combination of business name, business phone number, and a unique identifier for the proprietary authentication application.

Once the portal profile is complete an end user accesses, such as by a command bar giving one-click access to a standard set of tools of the portal. Examples of such portal tools comprise, but are not limited to:

Business location on map computed from street address;

Standard email and instant messenger functionality;

Card-forwarding utility; and

Add feature for bookmarks, buddy list, and address book.

It should be appreciated that in the preferred embodiment of the invention links may be placed on online business cards to other related business cards or related content.

Also, directory access to business card profiles, complete with advanced search and sort functions, is accomplished through a portal yellow pages business directory and/or an portal open directory for the end user as a portal member with a web site or home portal page. This offering is preferably a standard offering.

Vertical industry classification preferably is selected from portal yellow pages directory categories using a taxonomy browser. In addition to the core fields used to register for the portal home page, additional categories can be selected for placement in directories. The most popular categories preferably appear first in the browser.

The preferred embodiment of the invention provides readily available generic member services, such as, for example from a coupled proprietary system. For example, terms of service regarding use of language and business rules are enforced by a text scanner and a member services review. A member services review may be triggered by the presence of prohibited words or business practices, or registered objections of users.

Privacy policies of the portal preferably apply to all interactions on the portal site, and a user, such as a partner agrees to abide by such policies in collecting and using customer and supplier information.

Partners and the Marketing and Registration Wizard

In the preferred embodiment of the invention, if a service provided by a partner requires authentication, partners confer with the proprietary authentication application. It should be appreciated that the portal site preferably does not mediate authentication.

The preferred embodiment of the invention provides three levels of integration, each level based on how user profiles are accessed, as follows:

Minimal integration, when no information is needed from the portal profile database and only upsell and listing features are used;

No profile sharing is implemented if information is needed only at initial signup. This option saves considerably on integration effort; and

Close integration with profile sharing that initiates a close, longstanding relationship between the partner site and the portal site.

Information exchange with a portal team is preferably the first step, including both technical and service-related matters, such as, but not limited to:

For each service, portal and partner teams exchange configuration data;

The partner team lists profile attributes needed and the portal team provides an appropriate XML format document to the partner;

Sample XML Document Type Definitions (DTD) are provided to the partner team for profile exchange;

The portal team provides the XML document format the partner receives on a scheduled batch profile dump, if that profile sharing mechanism is chosen; and

The portal team provides a list of URLs to which HTTP requests are directed during initial service signup.

Thus, the claimed invention allows integration with many partner services and without requiring users to repeatedly provide profile attributes.

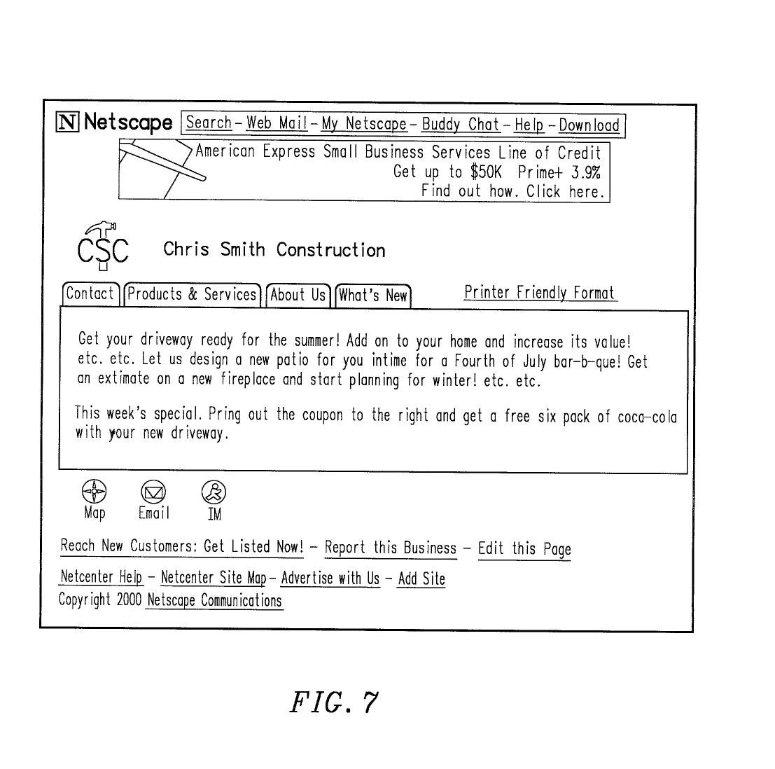

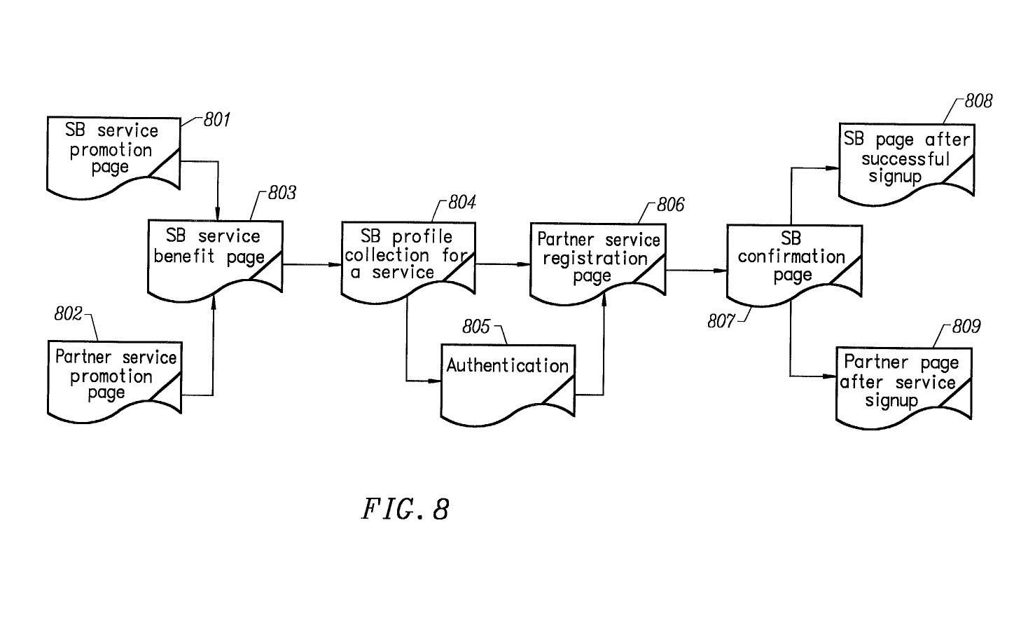

In the preferred embodiment of the invention, the signup process includes the nine steps depicted in FIG. 8 with related success/fail URLs and other items. A sample list of URLs is provided below. In this explanation, the portal site is a small business (SB) site. The portal promotion page, i.e. the SB promotion page or the partner's promotion page 802 is provided to the end user. The end user is then linked to a SB benefits page 803. SB profile information is collected 804 for the service or task for which the end user signs up. If necessary, end user authentication is performed by the proprietary authentication application 805. If necessary, the partner provides its own registration page for collecting additional information 806. A confirmation page is sent to the end user 807. The end user is passed to the SB page after successfully signing up 808, or if the end user desired to sign up for a partner service or task, the end user is passed to a partner page after a service signup 809.

A partner service can be accessed through a promotion on another site that is not the portal site. In this case, the partner preferably authenticates the end user through the proprietary authentication application before initiating the portal signup sequence.

If the user aborts the signup process after the benefit statement or at any other time, according to the preferred embodiment of the invention, the data is directed to a problem URL passed in the first step. In the case of incomplete sign-ups, a separate problem handler is used. Otherwise, user attributes are posted to a partner signup URL, a partner-specified URL that feeds data to the partner's server-side profile processing and database functions.

It should be appreciated that with posting processes the claimed invention uses invisible pages to avoid end user interaction. A sample JavaScript implementation is provided herein below.

For processing XML documents received from the portal site using an XML parser is preferably the approach to take because it is presently the easiest approach. Two major types of XML parsing are:

Document Object Model, or DOM API creates an internal tree structure from the XML document. Applications then navigate that tree. Such solution is intuitive; and

Simple API for XML, or SAX uses callbacks to report events as they occur. Handlers, much like those in a GUI, deal with events. This solution uses fewer system resources.

The preferred embodiment of the invention provides a profile editing feature wherein each profile edit uses two identifiers: a unique profile ID that never changes, and an integer specifying the number of times the profile has been modified.

According to the preferred embodiment of the invention, the order of tasks promoted by the marketing wizard are presented in an order that reflects the status of the end user according to the end user's profile, i.e. is coupled to the end user's profile and hence is not fixed. That is, the task list of the marketing wizard is flexible and dynamic. For example, the order of the task list is based upon, but not limited to, the following:

Order in which activities for an end user proceed;

Tasks which are already completed;

Industry vertical category;

Profile wherein tasked are recorded and marketed to end user; and

Likelihood an end user will perform the next task.

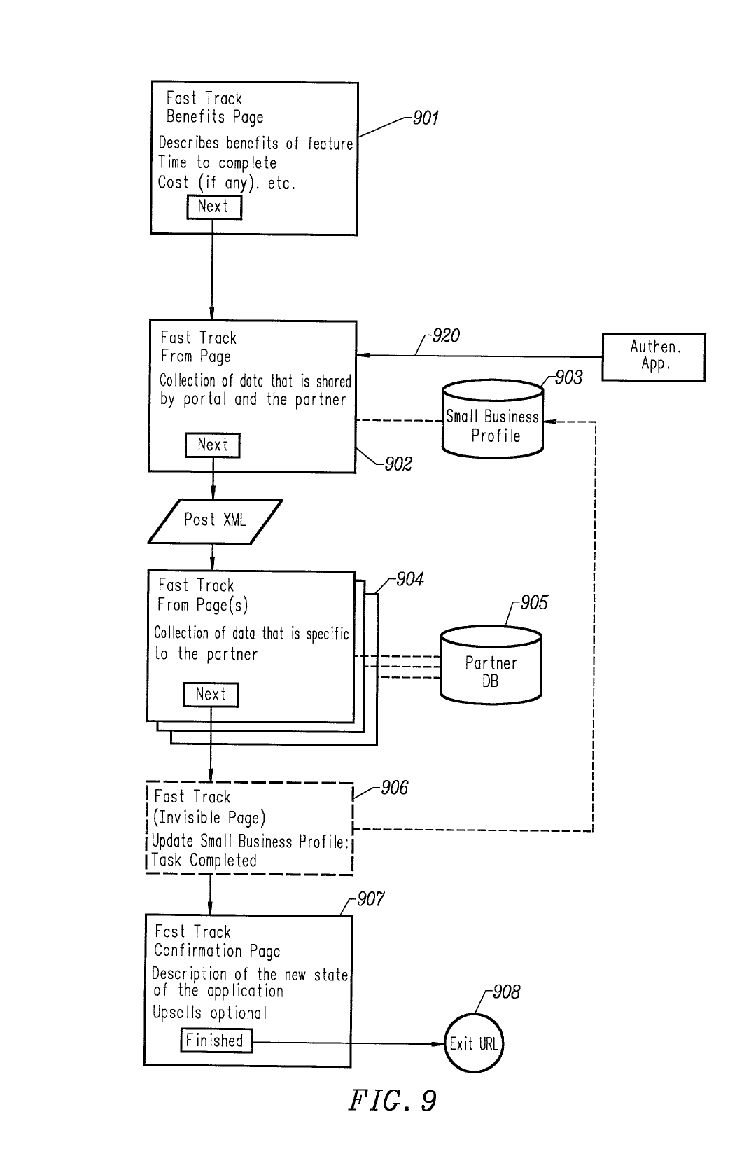

FIG. 9 is a flow diagram of the part of the marketing and registration wizard pertaining to the registration process, referred to simply as the registration wizard, according to the preferred embodiment of the invention. The registration wizard begins with the end user at the benefits page of a desired portal or partner service 901. At the benefits page, the end user preferably reads a description of the benefits of the desired feature or service, time to complete the registration process, and other relevant information, such as, for example, about cost. The end user then proceeds to a forms page 902 that is coupled to the portal profile database 903. The forms page 902 is coupled to an authentication application and full authentication is performed if required 920. Also at the forms page 902, the end user enters data intended to be shared by other portal users as well as a partner, should the feature and/or service be provided by a partner. An XML post brings the end user to form pages provided by the partner 904, if the feature and/or service is provided by a partner. The end user provides additional data to the partner for the partner to store in the partner's database 905. An invisible web page 906 is sent to the portal profile database for updating and the signup process is complete. A confirmation page 907 is sent to the end user. The confirmation page 907 provides the end user with a description of the new state of his environment and optionally upsells are presented to the end user. The registration wizard provides means for the end user to exit the registration wizard URL 908.

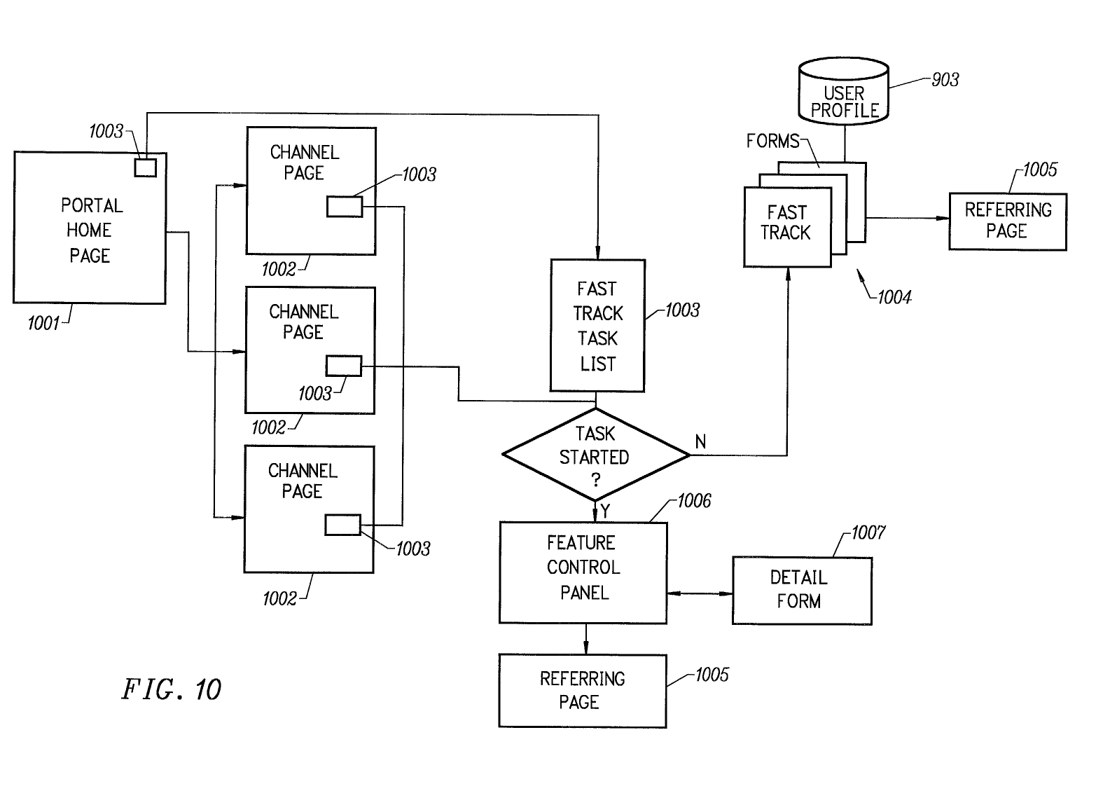

FIG. 10 is a flow diagram of the part of the marketing and registration wizard pertaining to the marketing process, referred to simply as the marketing wizard, according to the preferred embodiment of the invention. The business owner or end user is at his or her home page 1001 on the portal. The home page 1001 comprises objects 1002 each of which comprises links 1003 to the marketing, referred to also as the fast track or fast path wizard. Examples of such objects are channel pages. In another equally preferred embodiment of the invention, the home page comprises a direct link 1003 to the marketing wizard. Such links is a master list of tasks and/or subtasks that may or may not have been started. If the end user selects a task that has not been started, the end user is passed to marketing forms 1004 coupled to the portal user profile database 903 for specifying profile options. The end user is then passed to the appropriate referring page 1005 for registration. If the end user has started a task on the task list, the end user is passed to the desired feature and/or service's control panel 1006 and to corresponding detail forms 1007, if required, for completion. Then the end user is passed to the appropriate referring page 1005.

An Exemplary Marketing and Registration Wizard Integration—Fast Track

Following is a discussion of an exemplary small business marketing and registration wizard implementation. It should be appreciated that the discussion is not intended to be exhaustive, and that various modifications and enhancements may be made without departing from the spirit and scope of the invention.

Introduction

A small business (SB) portal is a primary gateway for business members of a larger proprietary domain to conduct daily business services online. The SB portal provides many business services, some of which are provided by the proprietary domain, and some of which are provided by partners. Most partner services are included in a category referred to as fast track services that are divided into the following two groups:

Dynamically Promoted: The SB portal web site has a fast track channel which provides targeted service promotion. Each business user receives promotions for a manageable number of services, such as, two services at any given time. Such promoted services are dynamically adjustable.

Statically Included Services: These services appear on various SB portal web pages, including a SB service list page and a business card page. It is preferable that these services are always presented as long as those web pages are not modified.

Business Profiles

The SB portal collects various business profile data from users along the way as users sign up for fast track services. Examples of collected business profile attributes comprise, but not limited to:

High level business information such as business name, industry classification, and affiliations;

Business contact information including address, phone, email, web site URL, and the like;

Business product/service information such as product/service description, service area, carried product brands, and accepted credit cards; and

Reference information of the business.

It should be appreciated that for efficiency none of these business profile attributes are available from the proprietary authentication application or server, which collects individual profile attributes, such as, but not limited to, resident address, birthday, education level, and the like.

Service Signup

A partner service can be promoted at the partner site in addition to the SB portal. A SB user clicks a signup link that points to an HTML page explaining the benefit of the service. Then, the user is directed to a SB portal page that displays a list of business profile attributes needed for service registration. The user performs any necessary modification at this page. When a SB user is introduced to a partner for service registration, a SB partner receives a list of business profile attributes from the SB portal. The SB partner then collects any remaining or additional data from the user before qualifying the user for the service. After the user registration is complete, the SB partner sends the user back to the SB portal site. The SB portal displays a confirmation page to the user.

If a partner service is not hosted in, or a part of the proprietary domain, for example, due to privacy constraints, the SB portal does not forward the name identifier of the user to the partner. The SB partner uses the proprietary authentication application service for authentication and thereby obtains the user's name identifier.

Profile Editing

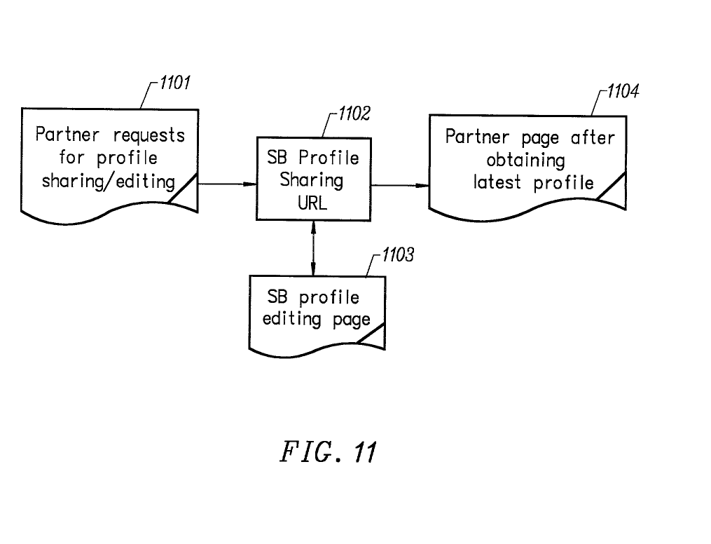

Profile editing can be described with reference to FIG. 11. SB partners do not allow a SB portal user to modify any SB business profile attributes at the partners' own sites. Instead, it is preferred that SB partners, receiving requests for profile sharing 1101 send the user back to the SB portal for modification 1102. After modifying the business profile 1103, the user is sent back from the SB portal to the partner site together with the updated profile data 1104. By enforcing this policy, the SB site always has the most updated profile information, and users enjoy a consistent web experience for maintaining the user's profile.

Profile Sharing

The SB portal provides two mechanisms for on-going profile sharing:

Profile batch dump: The SB portal produces an XML file every night/week for a partner. The partner then pulls the XML file via HTTP. Profile attributes of users who have signed-up for the service are shared.

Instant profile fetching: For an authenticated user, a SB partner pulls the business profile of that user from the SB portal via HTTP as depicted in FIG. 11. This mechanism enables SB partners to ensure that they have the latest profile data of users.

Service Classification

Fast track services are classified into three categories based on how SB profile attributes are accessed:

A partner service not needing SB profile attributes;

A partner service that only needs SB profile attributes at the initial sign-up phase; and

A partner service that needs on-going sharing of SB profile attributes.

Service Configuration Data

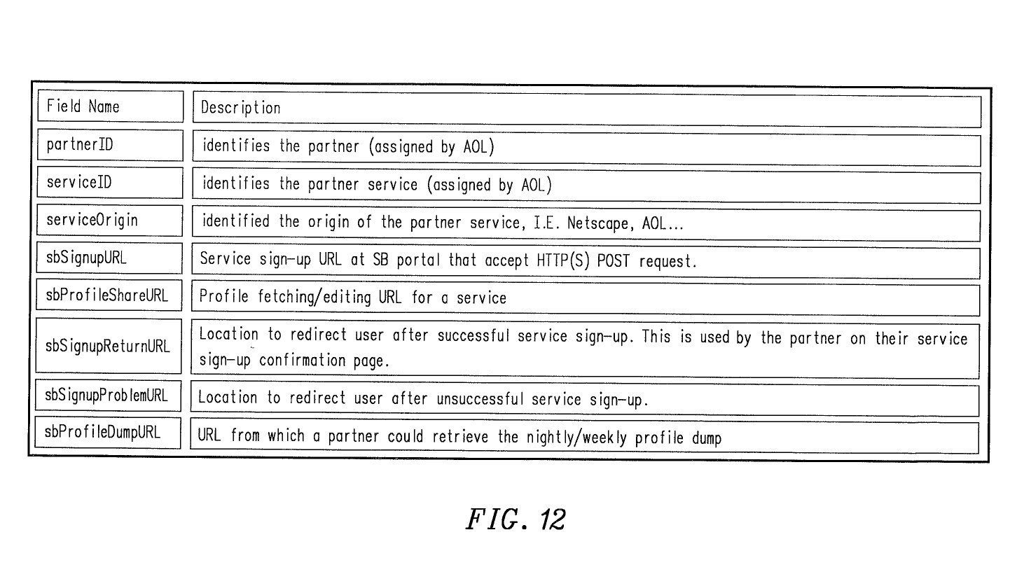

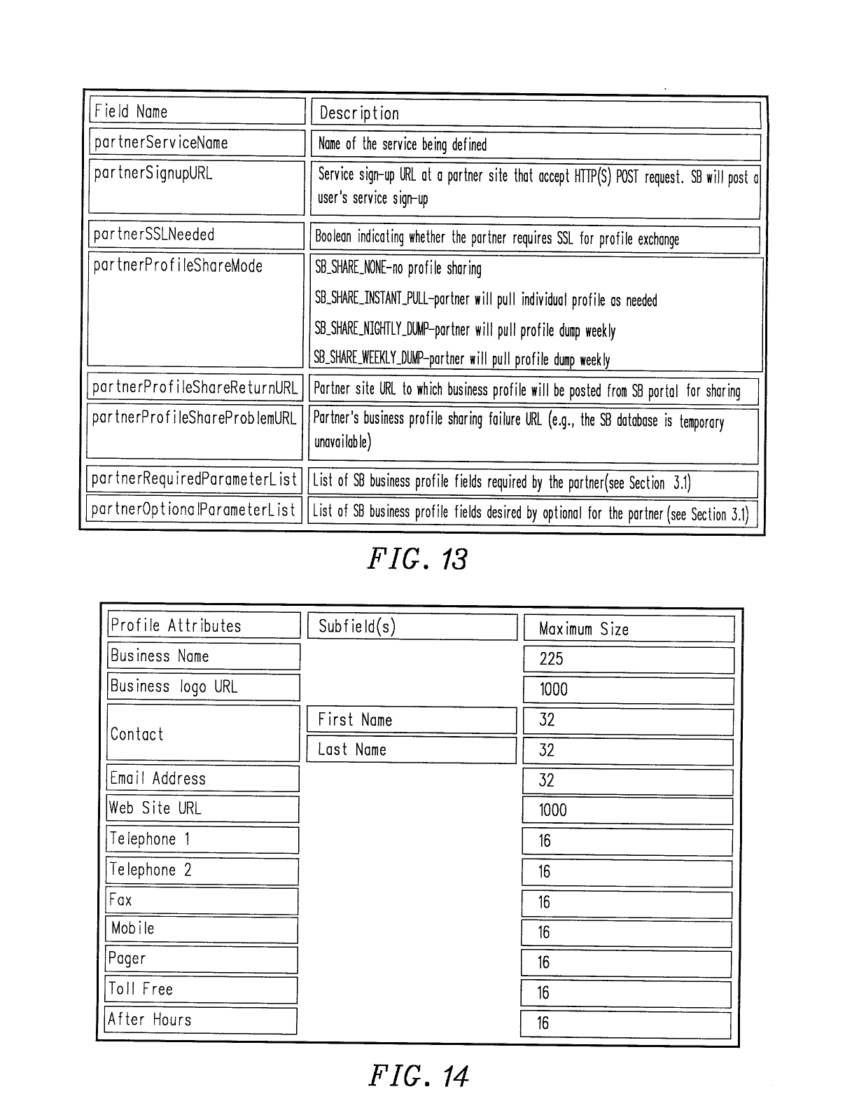

FIGS. 12 and 13 provide configuration data that the SB portal provides to SB partner sites, and the configuration data that the SB partner sites must supply to the SB portal for each service, respectively.

XML Based Business Profile Exchange

Business Profile Attributes

The following figures show lists of SB business profile attributes that are available to partner sites:

Contact Info;

Refer to FIG. 14

Business Address;

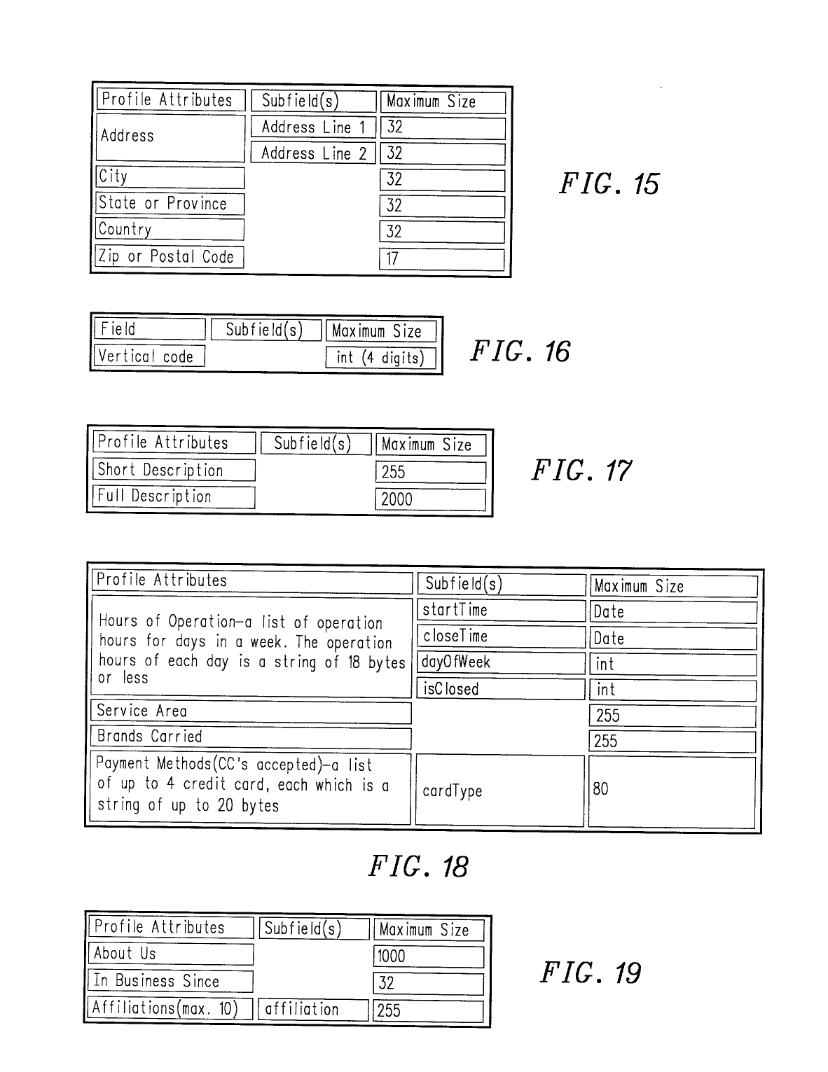

Refer to FIG. 15

Business Taxonomy;

Refer to FIG. 16

SIC code is found at several web sites of US government such as http://www.osha.gov/oshstats/sicser.html;

Business Description;

Refer to FIG. 17

Business Details;

Refer to FIG. 18

About the business;

Refer to FIG. 19

References; and

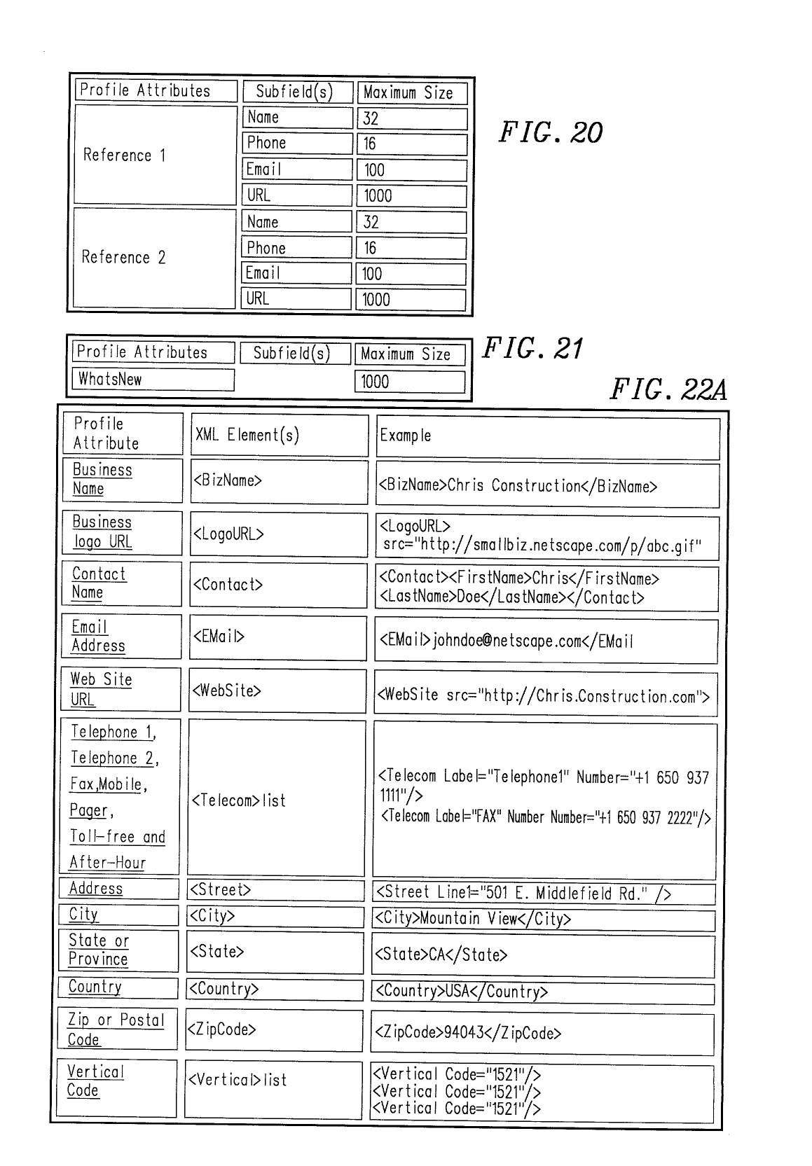

Refer to FIG. 20

What's New;

Refer to FIG. 21.

XML Format for Representing A Single Business Profile

This section describes XML data format that the SB portal uses for representing single business profile attributes. Profile attributes are represented by the following XML elements.

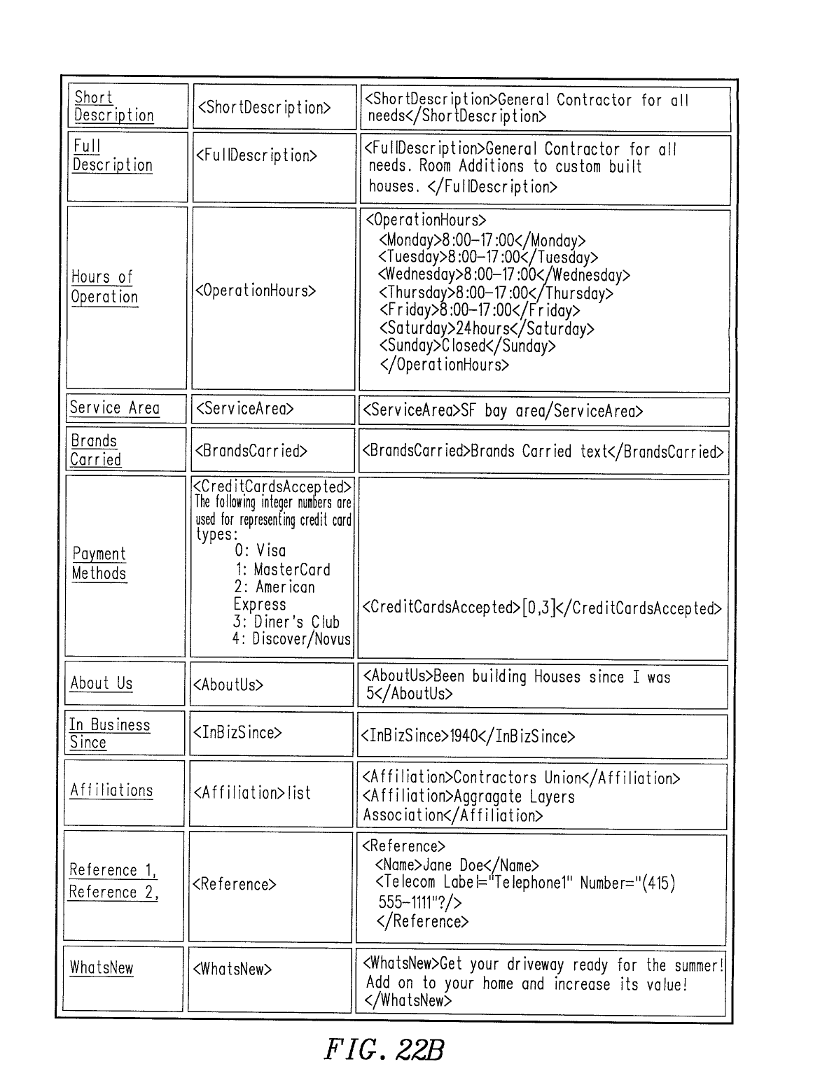

Please reference FIG. 22.

The following XML elements are used to organize profile attributes presented in FIG. 22.

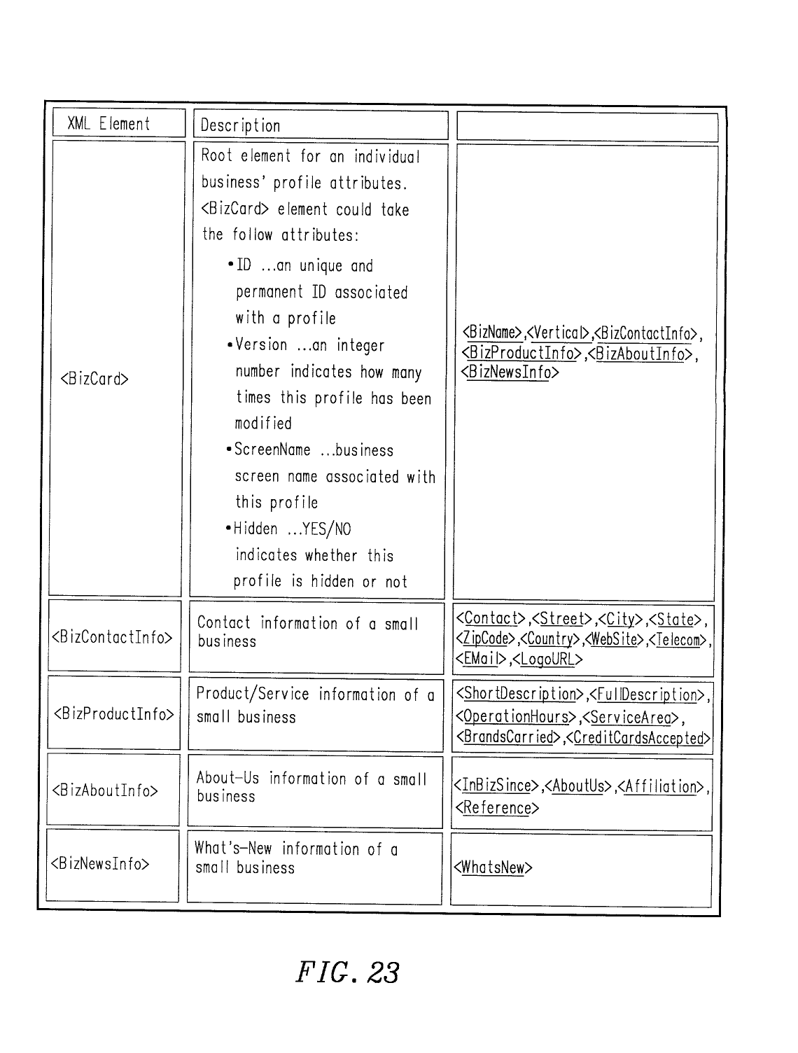

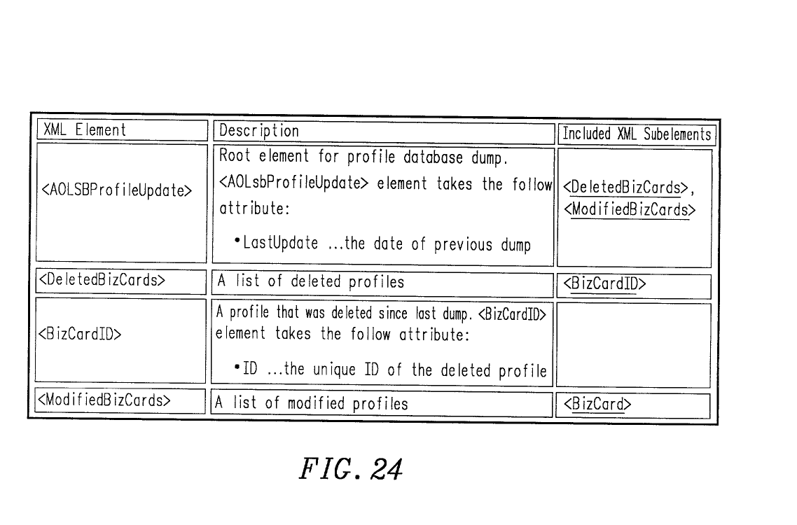

Please reference FIG. 23.

Based on a subset of profile attributes needed for a partner service, the SB portal composes an XML document for profile sharing. The XML document includes a subset of XML elements mentioned above. As an example, consider a service that needs the following profile attributes:

Business Name represented as <BizName>

Contact Name represented as <Contact>

Email Address represented as <EMail>

Telecommunications represented as <Telecom>

References represented as <Reference>

For such a service, the SB portal offers XML documents of the following format for profile sharing as shown below in Table A.

TABLE A
<!DOCTYPE BizCard SYSTEM “AOLSBProfileUpdate.dtd”>
<BizCard ID=“2458787” ScreenName=“construction567”
Version=“122”>

<BizName>Chris Construction</BizName>
<Vertical Code=“1521”/>
<BizContactInfo>

<Contact>

<FirstName>Chris</FirstName>
<LastName>Doe</LastName>

</Contact>
<Telecom Label=“Telephone1” Number=“+1 650 123 1111”/>
<EMail>johndoe@nets.com</EMail>

</BizContactInfo>
<BizAboutInfo>

<Reference>

<Name>ABC Construction Supplier</Name>
<Telecom Label=“Telephone1”
Number=“+1 650 123 3456”/>

</Reference>
<Reference>

<Name>Janet Smith</Name>
<Telecom Label=“Telephone1”
Number=“+1 650 123 6789”/>

</Reference>

</BizAboutInfo>

</BizCard>

XML Format for Representing Profile Database Dump

This section describes the XML document format that partners receive through the nightly/weekly profile database dump. In a nutshell, the XML document of the database dump comprises, but is not limited to the following information:

a list of small businesses that have been deleted since the previous dump; and

a list of business profiles that have been modified since the previous dump.

In addition to the XML elements mentioned above, the following XML elements are used for representing a profile dump.

Please reference FIG. 24.

### EXAMPLE

Consider a case wherein profiles 123 and 456 are deleted, and profiles 666 and 888 are modified. A service partner gets the following nightly/weekly dump as shown in Table B below if the service only needs the following two profile attributes:

Business Name; and

Vertical SIC.

TABLE B
<!DOCTYPE AOLSBProfileUpdate
SYSTEM “AOLSBProfileUpdate dtd”>
<AOLSBProfileUpdate LastUpdate=“05/01/2000”>

<DeletedBizCards>

<BizCardID ID=“123”/>
<BizCardID ID=“456”/>

</DeletedBizCards>
<ModifiedBizCards>

<BizCard ID=“666” Version=“10”>

<BizName>Chris Construction</BizName>
<Vertical Code=“1521”/>

</BizCard>
<BizCard ID=“888” Version=“18”>

<BizName>Bob's Construction</BizName>
<Vertical Code=“1531”/>

</BizCard>

</ModifiedBizCards>

</AOLSBProfileUpdate>

XML Parsers and APIs

XML documents are plain text files, and thus SB partners can use any of their preferred mechanisms to process XML documents received from the SB portal. An easy approach, however, is to use XML parsers for processing XML documents. There are many XML parsers available in the market. W3C web site, for example, has a list of XML parsers that are available for free noncommercial use. Two major types of XML APIs, DOM API and SAX API are discussed above.

DOM API provides a set of intuitive classes and methods for tree navigation. To process the profile database dump mentioned above, a Java program is used, for example, as in Table C below:

TABLE C

//<AOLSBProfileUpdate> element
Element element = document.getDocumentElement();
//<DeletedBizCards>
Element child = element.getFirstChild();
//<BizCardID> of deleted profiles

for (Element delCrd=child.getFirstChild();

delCrd!=null;
delCrd=delCrd.getNextSibling())

{
String delCrd_ID = delCrd.getAttribute(“ID”);

...
}
// <ModifiedBizCards>
child = child.getNextSibling();
//<BizCard> of modified profiles

for (Element modCrd=child.getFirstChild();

modCrd!=null;
modCrd=modCrd.getNextSibling())

{

...

}

DOM API is used in SB portal service reference implementations. DOM API may put a strain on system resources when XML documents are large. In that case, consider using SAX API.

Technical Details on Service Sign Up

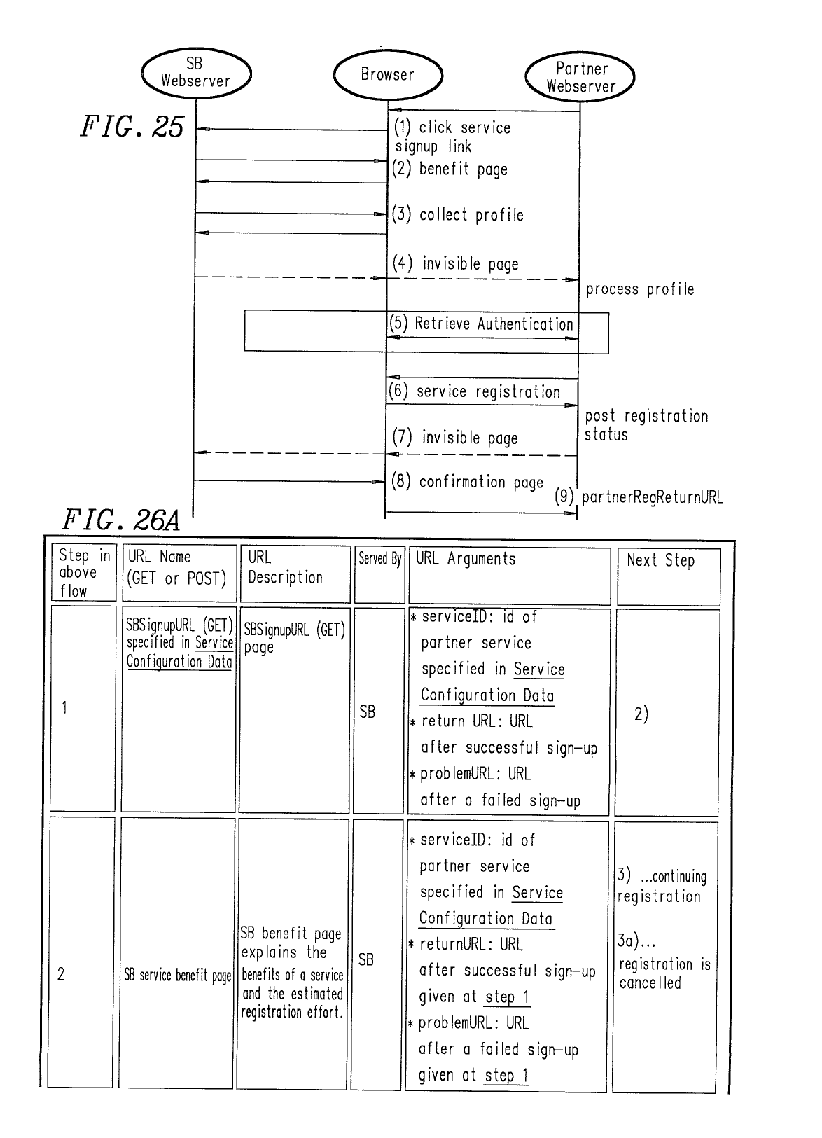

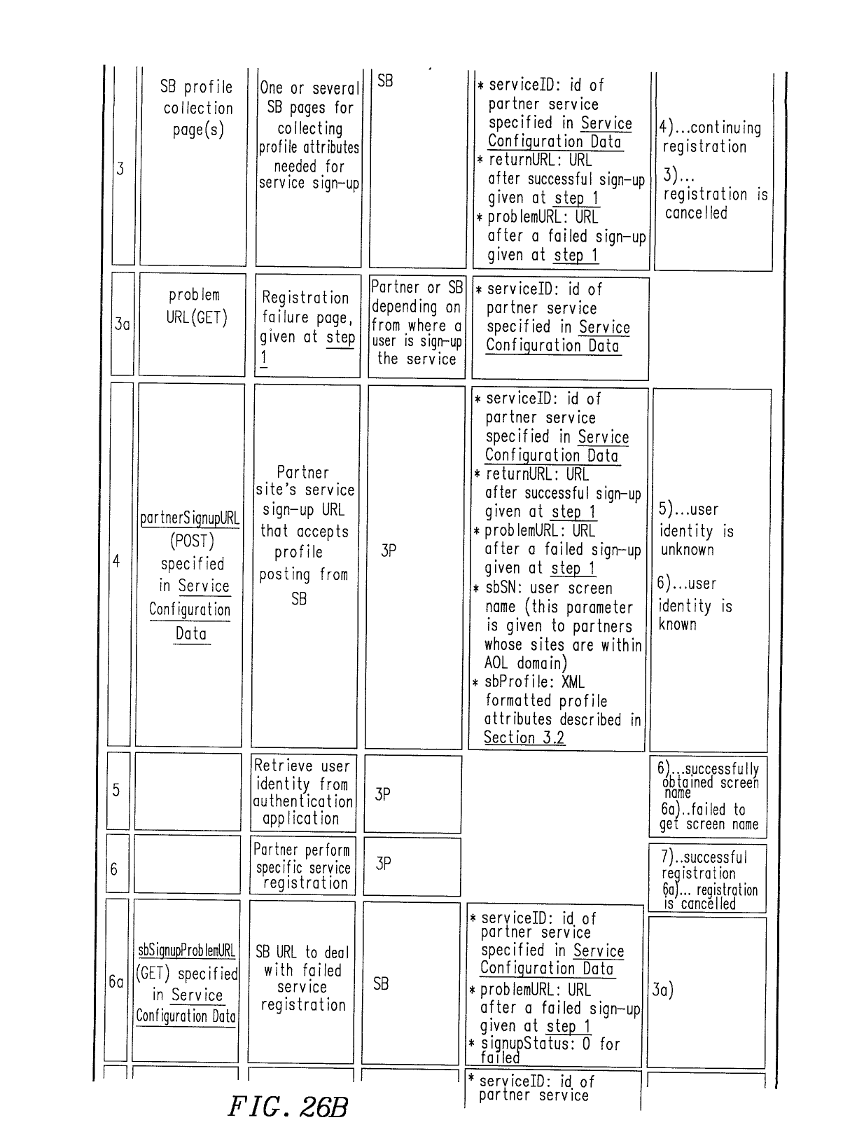

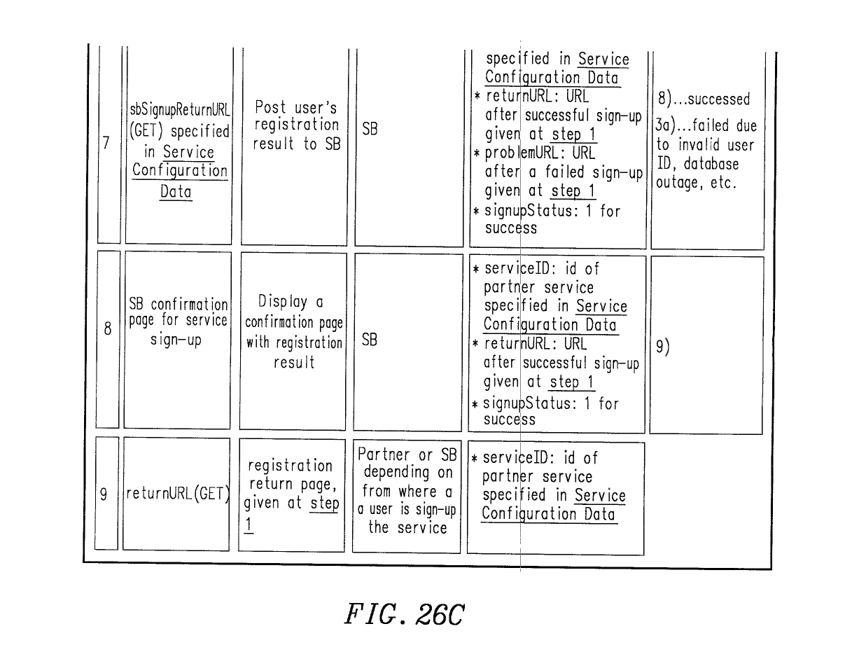

FIG. 25 illustrates the overall page flow during a service sign-up process. FIG. 26 provides additional details, such as, for example, success/fail URLs not illustrated in FIG. 25 above.

Recall that a service can be promoted at SB portal and partner sites. Before sending users to the SB portal for service sign-up, a partner site preferably is encouraged to perform user authentication via the proprietary authentication service.

For each service sign-up, a user first understands service benefit together with estimated registration effort. This is achieved by a service benefit page. After, the SB portal collects necessary profile attributes from the user. Meanwhile, if the user decides to cancel service registration, the user is directed to a URL specified as problemURL, which was already passed in. Otherwise, the user is directed to partnerSignupURL, which is a partner URL specified.

The SB portal site posts the user's profile attributes (via XML format) to the above partnerSignupURL. The partner has a server-side program to process the profile and save profile attributes into the partner database. If the user identity is unknown, e.g. the user signs up this service from the SB portal, a the partner server preferably performs user authentication via the proprietary authentication service. Partners can collect additional information from users via partner specific registration pages.

When the user successfully completes service registration, the SB partner sends the user back to sbSignupReturnURL where a serverlet program is hosted by the SB portal. The SB portal updates its profile database to indicate that the user has completed service sign-up. The user receives a confirmation page, from which the user is directed to returnURL.

If the user fails to complete service registration, the SB partner sends the user back to sbSignupProblemURL. The SB portal updates its profile databases accordingly. The user is directed to partnerSignupURL.

The web browser is used as a medium for directing users from a partner site to the SB portal sbSignupReturnURL/sbSignupProblemURL. To avoid user interaction during the redirection process, partners create invisible web pages.

Among many other mechanisms, JavaScript is used for that purpose. Following in Table D is an example for an invsible HTML page.

TABLE D
<HTML><BODY>
<FORM name=pform METHOD=“GET”
ACTION=“sbSignupReturnURL”>

<INPUT TYPE=“HIDDEN” NAME=“serviceID”
VALUE=“123”>
<INPUT TYPE=“HIDDEN” NAME=“signupStatus”
VALUE=“1”>
<INPUT TYPE=“HIDDEN” NAME=“returnURL”
VALUE=“returnURL”>
<INPUT TYPE=“SUBMIT” NAME=“SUBMIT”
VALUE=“SUBMIT”>

</FORM>

<SCRIPT LANGUAGE=“JAVASCRIPT”>
<!-- Hiding the code

document.pform.submit();
// done hiding -->

</SCRIPT>

</BODY></HTML>

This HTML page is produced by a partner web site. Once this page arrives at the web browser, the JavaScript statement “document.pform.submit( )” is executed immediately. As a result, the SB portal gets an HTTP request at sbSignupReturnURL. If the JavaScript is disabled, the user needs to click the SUBMIT button for completing the redirection process.

Technical Details on Instant Profile Fetching/Editing

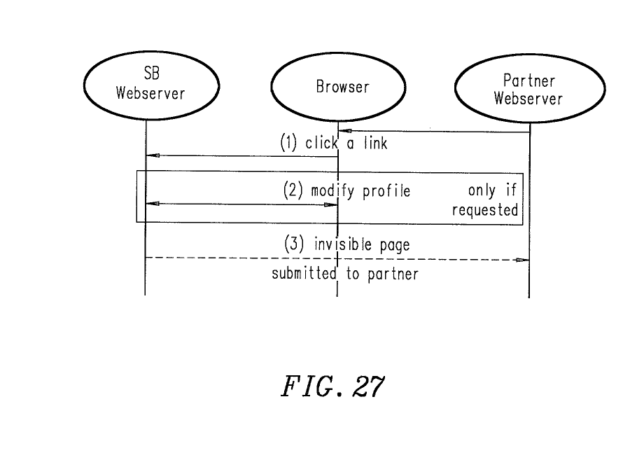

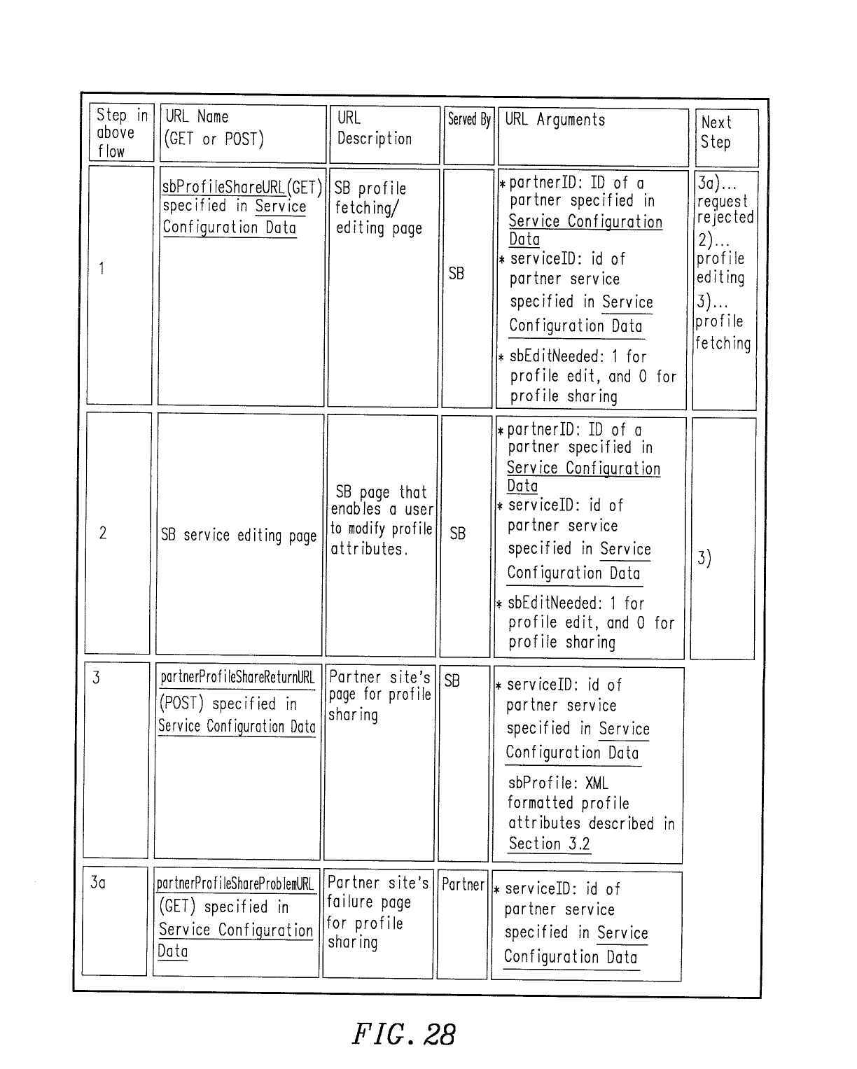

FIG. 27 illustrates the overall page flow for instant profile fetching/editing. FIG. 28 provides additional details, such as, success/fail URLs not illustrated in FIG. 27.

As mentioned above, the SB portal posts the latest profile attributes via a HTTP POST request in XML format. Following are two attributes of the <BizCard> element:

ID: This attribute represents a unique ID of a profile and never changes during the life of a profile; and

Version: This attribute is an integer number indicating how many times this profile has been modified.

By using the above attributes, a SB partner can easily decide whether or not it needs to update own database.

Although the invention has been described in detail with reference to particular preferred embodiments, persons possessing ordinary skill in the art to which this invention pertains will appreciate that various modifications and enhancements may be made without departing from the spirit and scope of the claims that follow.

1. A signup process for a portal site associated with a partner site, comprising:
presenting a portal promotion page or a partner promotion page;
from said promotion page, linking to a benefits page;
from said benefits page, collecting profile information for a desired task;
sending a confirmation page associated with said desired task; and
linking to a portal page corresponding to said portal promotion page and corresponding to said desired portal task, or linking to a partner page corresponding to said partner promotion page and corresponding to said desired partner task.

2. The process of Claim 1, further comprising:
providing user authentication.

3. The process of claim 1, further comprising:
providing an additional partner registration page for collecting additional information for said partner.

4. The process of claim 1, further comprising:
using invisible pages for processing to avoid end user interaction.

5. An apparatus for signing up for a feature on a portal site or on a partner site associated with said portal site, said apparatus comprising:
a benefits page describing benefits of said feature, time to completion of said signing up, cost, and the like;
at least one form page for collecting user profile data, said user profile data accessible by said portal site and said partner site, if said feature is provided by said partner;
a portal profile database for storing said collected user profile data;
means for posting an XML post to at least one form page provided by said partner for collecting partner specific data, if said feature is provided by said partner;
a partner database for storing said collected partner specific data;
an invisible web page for sending updated information to said portal profile database;
a confirmation page for providing, but not limited to, a description of resulted new state from said signing up of said feature and optional upsells.

6. The apparatus of claim 5, further comprising means for authentication, said means coupled to said at least one form page.

7. A marketing process for a portal site associated with a partner site, comprising:
providing a customized home page on said portal site;
said portal home page linking to a list of t asks, wherein any of said tasks may have been started;
if an unstarted task is selected:
passing to marketing forms coupled to a portal user profile database for specifying profile options;
passing to an appropriate referring page for registration;
if a started task is selected:
passing to a control panel associated with said desired task, said control panel having corresponding detail forms for completion; and
passing to an appropriate referring page for registration.

8. The process of claim 7, wherein said tasks comprise subtasks.

9. A method for profile sharing/editing, comprising:
upon receiving a request for sharing/editing a profile on a partner site, passing said request to an associated portal site;
modifying and/or manipulating said profile on said portal site;
passing updated profile data from said portal site to said partner site, thereby ensuring said portal site always has the most updated profile information, and providing a consistent web experience for maintaining said profile.

10. A process for signing up from a browser for a service provided by a partner webserver, said partner webserver associated with a portal webserver, said process comprising:
from said partner webserver, selecting a service signup link;
informing said portal webserver of said selection;
said portal webserver showing a benefit page on said browser;
from said browser positively informing said portal webserver desire to signup for said service;
from said portal webserver requesting profile information from said browser;
said portal webserver collecting said profile information and sending an invisible page to said partner webserver, said invisible page containing information for processing profile on said partner webserver;
from said partner webserver requesting additional service registration information from said browser;
from said browser supplying said additional service registration information for posting said additional service registration information on said partner webserver;
said partner webserver sending a second invisible page through said browser to said portal webserver;
said portal webserver sending said browser a confirmation page; and
said browser being referred to said partner webserver.

11. The process of claim 10, further comprising:
retrieving authentication status associated with said profile information.

12. A process for modifying a profile from a browser to a partner webserver, comprising:
clicking a link on said partner webserver, said link indicating desire to modify said profile;
said partner webserver notifying an associated portal webserver of said desire to modify said profile;
said portal webserver facilitating modifying said profile from said browser;
said portal webserver sending an invisible page to said partner webserver, said invisible page containing modified information.

13. A marketing and registration system used by a portal system for promoting portal and/or partner functionality, comprising:
means for gathering data from a portal system profile database; and
means for providing portal system and/or partner tasks, using said gathered profile data;
wherein said tasks are provided in a logical and consistent fashion.

14. The system of claim 13, wherein said tasks comprise, but are not limited to portal and/or partner services and portal and/or partner tools.

15. The system of claim 13, wherein providing said tasks further comprises providing description of tasks and description of benefits of said tasks.

16. The system of claim 13, further comprising:
means for processing responses, thereby dynamically sequencing said tasks, and storing said dynamic sequencing in said portal profile database.

17. The system of claim 13, further comprising:
means for being actuated from a customized home page of said portal system.

18. The system of claim 13, wherein said tasks comprise, but are not limited to targeted advertising, special offers, and promotions.

19. The system of claim 13, further comprising:
a registration process for collecting user information for said portal system profile database.

20. The system of claim 19, wherein part or all of said collected user information is specified by said partner.

21. The system of claim 20, wherein said partner specified user information is stored in a partner database.

22. The system of claim 13, further comprising:
means for removing a completed task from said tasks upon completing registering for said completed task.

23. The system of claim 13, further comprising:
means for deleting and/or editing a task through the portal system.

24. The system of claim 15, wherein said description of tasks and/or description of benefits of tasks comprise at least one link to detailed benefits information.

25. The system of claim 24, wherein said detailed benefits information comprises at least one link to partner-hosted registration information.

26. The system of claim 25, wherein said partner-hosted registration information comprises pre-populated fields, said fields populated with information from said portal system profile database.

27. The system of claim 26, wherein said completed partner-hosted registration information is stored in a database of said partner.

28. The system of claim 13, further comprising:
means for providing user authentication.

29. The system of claim 28, wherein said means for providing user authentication uses a proprietary authentication application.

30. The system of claim 29, wherein some profile information is stored in a database coupled to said authentication application.

31. The system of claim 13, further comprising:
recommendations for requiring partner integration, said recommendations comprising, but not limited to:
integrating when contract with portal site includes complex data synchronization, registration form pre-population, or upselling placement.

32. The system of claim 13, further comprising:
an online business card for gathering user information, wherein said user information comprises, but is not limited to:
contact information;
product and services information;
about information; and
what's new information.

33. The system of claim 13, further comprising:
means for reconciling data for keeping profiles current.

34. The system of claim 33, wherein means for reconciling data comprises any of, but is not limited to:
a scheduled batch process;
a triggered process, actuated by an outdated profile version notation; and
instant fetching.

35. The system of claim 13, further comprising:
means for profile editing.

36. The system of claim 35, wherein said profile editing is performed on portal system to ensure said portal system has most updated profile information.

37. The system of claim 32, further comprising:
means for providing confirmation notification upon successful signup of said online business card.

38. The system of claim 37, wherein said confirmation notification comprises any of, but is not limited to:
description of signed up for task;
recommendations for next tasks based on profile information; and
a list of subscribed tasks.

39. The system of claim 32, wherein said online business card comprises any of, but is not limited:
a unique state, whereby no two online business cards contain identical information;
at least one link to other online business cards or related content; and
means for being linked to from portal system yellow pages directory or open directories.

40. The system of claim 13, wherein said portal tasks comprise, but are not limited to:
business location on map computed from street address;
standard email and instant messenger functionality;
card-forwarding utility; and
add feature for bookmarks, buddy list, and address book.

41. The system of claim 13, further comprising:
means for providing generic member services for a coupled proprietary system.

42. A marketing and registration method used by a portal system for promoting portal and/or partner functionality, comprising:
gathering data from a portal system profile database; and
providing portal system and/or partner tasks, using said gathered profile data;
wherein said tasks are provided in a logical and consistent fashion.

43. The method of claim 42, wherein said tasks comprise, but are not limited to portal and/or partner services and portal and/or partner tools.

44. The method of claim 42, wherein providing said tasks further comprises providing description of tasks and description of benefits of said tasks.

45. The method of claim 42, further comprising:
processing responses, thereby dynamically sequencing said tasks, and storing said dynamic sequencing in said portal profile database.

46. The system of claim 42, further comprising:
being actuated from a customized home page of said portal system.

47. The method of claim 42, wherein said tasks comprise, but are not limited to targeted advertising, special offers, and promotions.

48. The method of claim 42, further comprising:
providing a registration process for collecting user information for said portal system profile database.

49. The method of claim 48, wherein part or all of said collected user information is specified by said partner.

50. The method of claim 49, wherein said partner specified user information is stored in a partner database.

51. The method of claim 42, further comprising:
removing a completed task from said tasks upon completing registering for said completed task.

52. The method of claim 42, further comprising:
deleting and/or editing a task through the portal system.

53. The method of claim 44, wherein said description of tasks and/or description of benefits of tasks comprise at least one link to detailed benefits information.

54. The method of claim 53, wherein said detailed benefits information comprises at least one link to partner-hosted registration information.

55. The method of claim 54, wherein said partner-hosted registration information comprises pre-populated fields, said fields populated with information from said portal system profile database.

56. The method of claim 55, wherein said completed partner-hosted registration information is stored in a database of said partner.

57. The method of claim 42, further comprising:
providing user authentication.

58. The method of claim 57, wherein said providing user authentication uses a proprietary authentication application.

59. The method of claim 58, wherein some profile information is stored in a database coupled to said authentication application.

60. The method of claim 42, further comprising:
providing recommendations for requiring partner integration, said recommendations comprising, but not limited to:
integrating when contract with portal site includes complex data synchronization, registration form pre-population, or upselling placement.

61. The method of claim 42, further comprising:
providing an online business card for gathering user information, wherein said user information comprises, but is not limited to:
contact information;
product and services information;
about information; and
what's new information.

62. The method of claim 42, further comprising:
reconciling data for keeping profiles current.

63. The method of claim 62, wherein reconciling data comprises any of, but is not limited to:
providing a scheduled batch process;
providing a triggered process, actuated by an outdated profile version notation; and
providing instant fetching.

64. The method of claim 42, further comprising:
profile editing.

65. The method of claim 64, wherein said profile editing is performed on portal system to ensure said portal system has most updated profile information.

66. The method of claim 61, further comprising:
providing confirmation notification upon successful signup of said online business card.

67. The method of claim 66, wherein said confirmation notification comprises any of, but is not limited to:
description of signed up for task;
recommendations for next tasks based on profile information; and
a list of subscribed tasks.

68. The method of claim 61, wherein said online business card comprises any of, but is not limited:
a unique state, whereby no two online business cards contain identical information;
at least one link to other online business cards or related content; and
means for being linked to from portal system yellow pages directory or open directories.

69. The method of claim 42, wherein said portal tasks comprise, but are not limited to:
business location on map computed from street address;
standard email and instant messenger functionality;
card-forwarding utility; and
add feature for bookmarks, buddy list, and address book.

70. The method of claim 42, further comprising:
providing generic member services for a coupled proprietary system.
